(19) United States
(12) Patent Application Publication
(10) Pub. No.: US 2006/0198616 A1
(43) Pub. Date: Sep. 7, 2006

(54) Optical disc playback apparatus and control program for controlling optical disc playback apparatus

(75) Inventor: Masahiko Ojima, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/368,621

(22) Filed: Mar. 7, 2006

(30) Foreign Application Priority Data
Mar. 7, 2005 (JP) 2005-062654

(51) Int. Cl. H04N 5/00

(52) U.S. Cl. 386/126

(57) ABSTRACT

According to one embodiment, program chain information indicating a playback order is read at the start of reading. In accordance with the playback order of the program chain in this program chain information, data is read from the optical disc to a buffer. Furthermore, the data which does not support playback, or the data pertaining to unselected audio or subtitle data is deleted from the buffer.

### CROSS-REFERENCE TO RELATED APPLICATIONS

This application is based upon and claims the benefit of priority from Japanese Patent Application No. 2005-062654, filed Mar. 7, 2005, the entire contents of which are incorporated herein by reference.

### BACKGROUND

1. Field

One embodiment of the invention relates to an optical disc playback apparatus and a control program therefor to play back a Digital Versatile Disk (DVD) and the like.

2. Description of the Related Art

Recently, an optical disc playback apparatus for playing back a Compact Disc (CD), DVD, and the like has become very popular. In this optical disc playback apparatus, since the data playback speed is generally lower than the data read speed of an optical disc, data is intermittently read from the optical disc. Conventionally, an optical disc drive is driven even while data is not being read from the optical disc, thus wasting power.

To cope with this problem, in order to reduce power consumption, it has been proposed to perform power saving control for the optical disc drive while not reading data from the optical disc.

It is disclosed by, for example, Jpn. Pat. Appln. KOKAI Publication No. 6-318359, upon reading a predetermined amount of data from the optical disc, power saving control such as stopping rotational drive is performed for the optical disc drive for a predetermined time. With this operation, power consumption can be reduced.

However, in the scheme disclosed in Jpn. Pat. Appln. KOKAI Publication No. 6-318359, when an address for reading data is designated, a predetermined amount of data is continuously read from the address. When this scheme is applied to a DVD or the like, data which is not used in playback processing, e.g., multiangle data or data pertaining to subtitles and audio data in an unselected language is also buffered. That is, memory efficiency decreases, access frequency to the optical disc drive increases, and power consumption also increases.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram showing an example of the arrangement of a notebook PC as an embodiment of an optical disc playback apparatus according to the present invention;

FIG. 2 is a view showing an example of the directory structure of the optical disc played back by the notebook PC as the embodiment of the optical disc playback apparatus according to the present invention;

FIG. 3 is a view showing an example of the arrangement of a management file VTS_01_0.IFO recorded on an optical disc;

FIG. 4 is a view for explaining program chain information;

FIG. 5 is a view showing an example of the arrangement of a cell on the optical disc;

FIG. 6 is a flowchart showing an example of a process flow when the notebook PC as the embodiment of the optical disc playback apparatus according to the present invention reads data in order to play back the optical disc;

FIG. 7 is a flowchart showing a detailed example of a process in step S603 shown in FIG. 6;

FIG. 8 is a timing chart for explaining an example of a relationship between disc drive unit control and a data amount in a pre-read buffer, in the notebook PC as the embodiment of the optical disc playback apparatus according to the present invention; and

FIG. 9 is a flowchart showing an example of a process flow when an audio or subtitle data switching request is received by the notebook PC as the embodiment of the optical disc playback apparatus according to the present invention.

### DETAILED DESCRIPTION

Various embodiments according to the invention will be described hereinafter with reference to the accompanying drawings. In general, according to one embodiment of the invention, an optical disc playback apparatus which plays back an optical disc on which a plurality of data units to be played back are recorded, comprises a reading unit configured to read data from the optical disc by controlling an optical disc drive, and a temporary storage unit configured to temporarily store the data read by the reading unit, wherein the reading unit performs power saving control for the optical disc drive when an amount of the data stored in the temporary storage unit reaches a first predetermined amount, and reads the data for each of the data units on the basis of playback order information which is read from the optical disc and pertains to a playback order of the data units.

According to another embodiment of the present invention, an optical disc playback apparatus which plays back an optical disc, comprises a reading unit configured to read data from the optical disc by controlling an optical disc drive, and a temporary storage unit configured to temporarily store the data read by the reading unit, wherein the reading unit performs power saving control for the optical disc drive when an amount of the data stored in the temporary storage unit reaches a predetermined amount, and deletes, from the temporary storage unit, an unselected data pertaining to audio data or sub-picture data which is not selected in playback processing, of the data stored in the temporary storage unit.

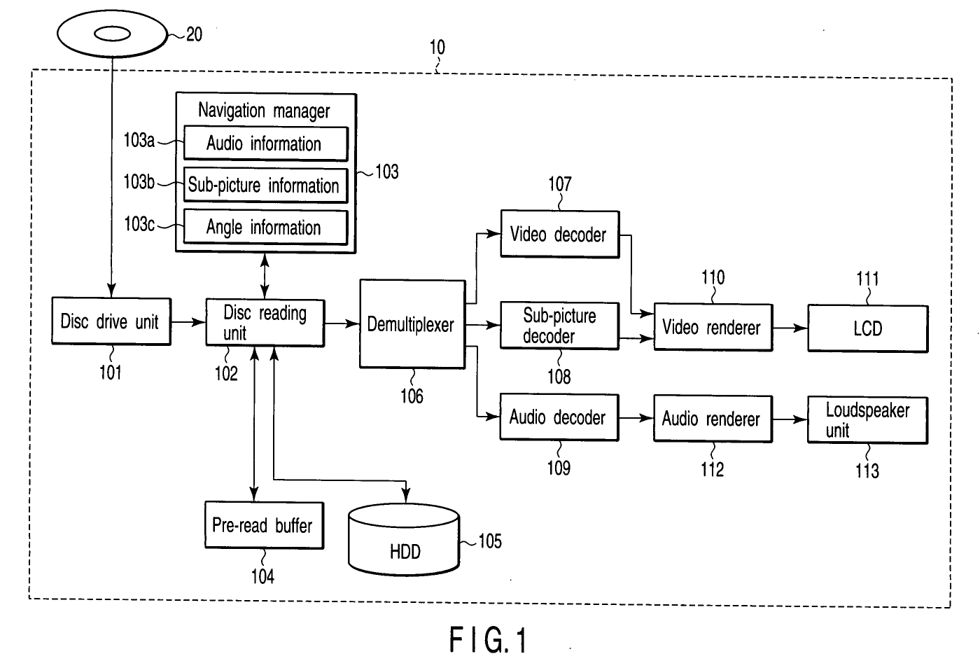

According to an embodiment, FIG. 1 is a block diagram showing the arrangement of a notebook PC as an embodiment of the optical disc playback apparatus according to the present invention. A notebook PC 10 includes a disc drive unit 101 such as an optical disc drive, a disc reading unit 102 which controls the disc drive unit 101, a navigation manager 103 which interprets a program chain (PGC) and designates data to be read by the disc reading unit 102, a pre-read buffer 104 in which the data read from an optical disc 20 is temporarily stored, a hard disk drive (HDD) 105, a demultiplexer 106 which demultiplexes the data into video data, audio data, and sub-picture data, a video decoder 107, a sub-picture decoder 108, an audio decoder 109, a video renderer 110, a liquid crystal display (LCD) 111, an audio renderer 112, and a loudspeaker unit 113. Of these devices, the disc reading unit 102, navigation manager 103, demultiplexer 106, video decoder 107, sub-picture decoder 108, audio decoder 109, video renderer 110, and audio renderer 112 are realized as programs to be executed by a CPU (not shown).

The disc drive unit 101 is a drive apparatus for reading the data from the optical disc 20. The disc drive unit 101 reads desired data by rotating the optical disc 20 and irradiating it with a laser beam.

Under the control of the navigation manager 103, the disc reading unit 102 obtains desired data from the optical disc 20 by controlling the disc drive unit 101. The data from the disc drive unit 101 is temporarily stored in the pre-read buffer 104. The disc reading unit 102 then deletes, from the pre-read buffer 104, data pertaining to the unselected audio and subtitle data of the data stored in the pre-read buffer 104, and stores the deleted data in the HDD 105. The navigation manager 103 interprets PGC information read from the optical disc 20, and designates the data to be read by the disc reading unit 102. Furthermore, the navigation manager 103 has audio information 103a pertaining to the selected audio data, sub-picture information 103b pertaining to the selected subtitle, and angle information 103c pertaining to the selected angle in playback processing. The navigation manager 103 designates, to the disc reading unit 102, the audio, subtitle, and angle data to be read and played back from the optical disc 20. More specifically, audio information 103a, sub-picture information 103b, and angle information 103c respectively correspond to an audio stream number, sub-picture number, and angle number of a system parameter (SPRM) held by the navigation manager 103.

In the pre-read buffer 104, the data read from the optical disc 20 is temporarily stored. In order to decrease an access frequency to the disc drive unit, the pre-read buffer 104 has a relatively large capacity of 100 Mbytes. As described above, the HDD 105 stores the data deleted from the pre-read buffer 104.

The demultiplexer 106 demultiplexes the data received from the disc reading unit 102 into video data, audio data, and sub-picture data. The video decoder 107 decodes the video data received from the demultiplexer 106, the sub-picture decoder 108 decodes the sub-picture data pertaining to the subtitle data and the like received from the demultiplexer 106, and the audio decoder 109 decodes the audio data received from the demultiplexer 106.

The video renderer 110 synthesizes the data decoded by the video decoder 107 and sub-picture decoder 108, converts the synthesized data into a video signal, and displays the obtained signal on the LCD 111. The audio renderer 112 converts the audio data decoded by the audio decoder 109 into an audio signal, and then outputs the obtained signal to the loudspeaker 113.

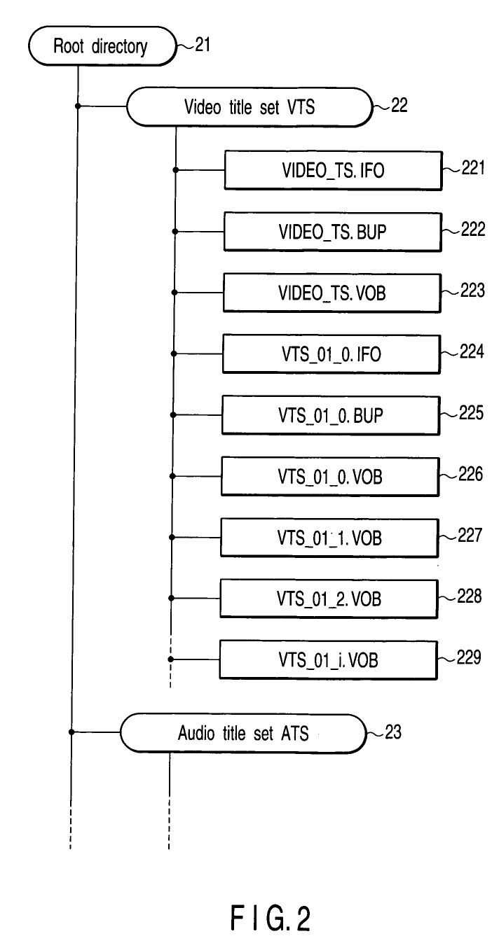

FIG. 2 is a view showing an example of the directory structure of information recorded on the optical disc 20. Similar to a hierarchical file structure employed in the versatile operating system of a computer, a sub-directory 22 of a video title set VTS, and a sub-directory 23 of an audio title set ATS exist under a root directory 21. Additionally, under the sub-directory 22 of the video title set VTS, there are a VIDEO_TS.IFO 221 and VTS_01_0.IFO 224 serving as management files, a VIDEO_TS.BUP 222 and VTS_01_0.BUP 225 serving as backup files for backing up the pieces of information of these management data files, and a VIDEO_TS.VOB 223, VTS_01_0.VOB 226, VTS_01_1_.VOB 227, VTS_01_2.VOB 228, . . . , VTS_{—01}_1.VOB 229 which are managed on the basis of the contents of the management data files, and they serve as video data files for storing digital moving image information.

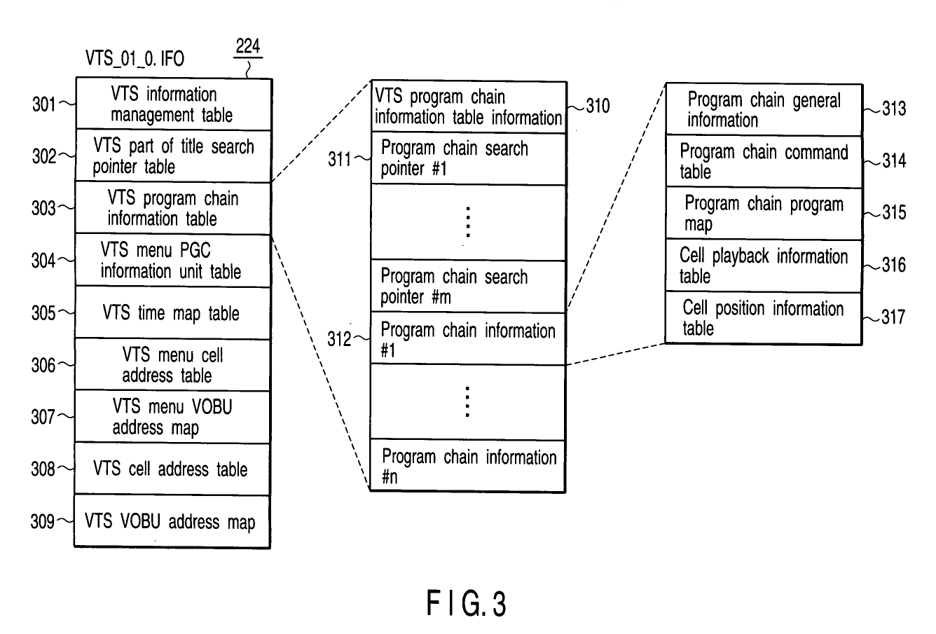

FIG. 3 is a view showing the arrangement of the VTS_01_0.IFO 224. As shown in FIG. 3, the VTS_01_0.IFO 224 contains a video title set (VTS) information management table 301, a title search pointer table 302 for a VTS part of title (e.g., program chapter), a VTS PGC information table 303, a VTS menu PGC information unit table 304, a VTS time map table 305, a VTS menu cell address table 306, a VTS menu video object unit address map 307, a VTS cell address table 308, and a VTS video object unit address map 309.

As shown in FIG. 3, the VTS program chain information table 303 contains VTS PGC information table information 310, one or more VTS PGC information search pointers 311, and one or more pieces of PGC information (PGCI) 312 (playback order information).

As shown in FIG. 3, the PGCI 312 contains PGC general information 313, a PGC command table 314, a PGC program map 315, a cell playback information table 316, and a cell position information table 317. For example, in the PGCI 312, the PGC general information 313 contains the contents and playback time of the PGC, and user control information. The cell playback information table 316 contains pieces of information such as the head address and end address, and the playback time of each cell included in the PGC.

That is, each PGCI 312 contains information pertaining to the cells in the PGC and the playback order of the cells. In playback processing, one PGC is selected. The navigation manager 103 interprets the PGCI 312 having the selected PGC, and causes the disc reading unit 102 to read data from the optical disc 20 in the playback order. With these operations, one program is played back.

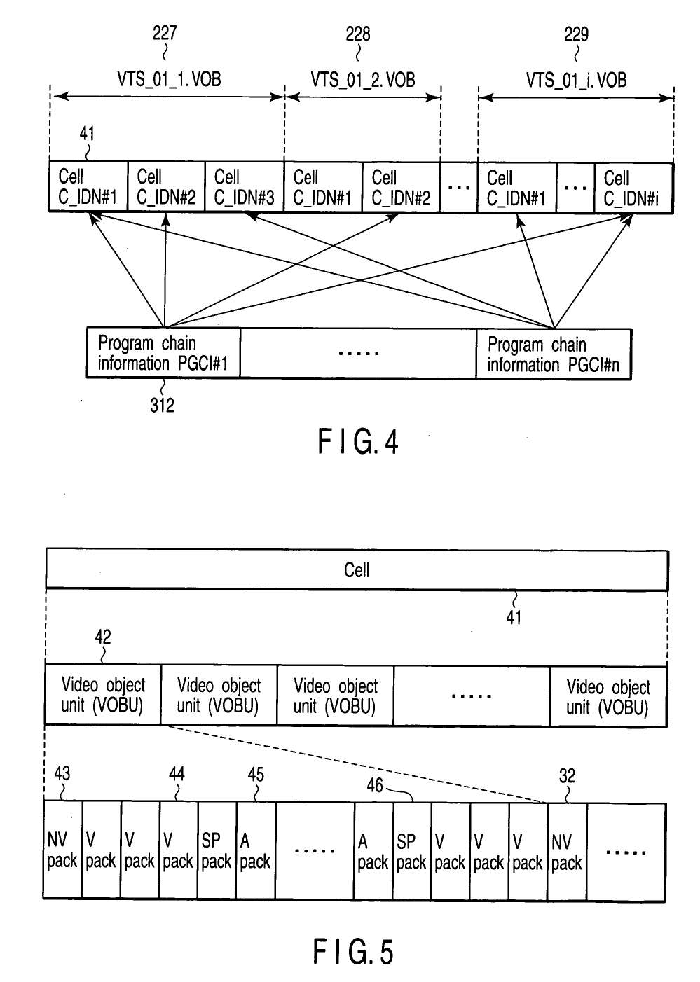

FIG. 4 is a conceptual view showing the concept of the PGCI 312. The PGCI 312 defines a set (data unit) of one or more cells 41 included in each of the PGC. Assuming that one PGC corresponds to one drama program, the plurality of cells 41 included in this PGC can correspond to various scenes in that drama. Note that one cell may be defined by a plurality pieces of PGCI 312.

Note that the cell 41 is a unit of a video object (VOB). The above-described VTS_01_1.VOB 227, VTS_01_2.VOB 228, and the like are each a set of one or more cells 41.

As shown in FIG. 5, each cell 41 is constructed by one or more video object units (VOBUs) 42 (data pack array). Each VOBU 42 is constructed as a set of a navigation pack (to be referred to as an NV pack hereinafter) 43 at the head of the set, a video pack (V pack) 44, a sub-picture pack (SP pack) 46 (sub-picture data pack), and an audio pack (A pack) 45 (audio data pack). That is, the VOBU 42 is defined as a set of all the packs recorded from a given NV pack 43 to immediately before the next NV pack 32. Each of these packs is a minimum unit for performing a data transfer process.

The playback time of the VOBU 42 corresponds to that of the video data constructed by one or more picture groups (GOPs), and is set to fall within the range of 0.4 to 1.2 sec. One GOP is frame data which normally has a playback time of about 0.5 sec in the MPEG standard, and is compressed to play back approximately 15 images during this interval.

When the VOBU 42 contains video data, GOPs each having a V pack 44, SP pack 46, and A pack 45 are arranged to construct the video data stream. However, regardless of the number of GOPs, the VOBU 42 is defined with reference to the playback time of the GOP. As shown in FIG. 5, the NV pack 43 is always arranged at the head of the set.

In the NV pack 43, the multiangle-compatible data is stored. More specifically, the data defines the relative address of the VOBU to be read next when a user switches or does not switch the angle.

The data pertaining to the video data is stored in the V pack 44, the audio data pertaining to audio data is stored in the A pack 45, and the data pertaining to sub-picture data corresponding to the subtitle is stored in the SP pack 46. When the currently played back contents are multilingual-compatible data, the A pack 45 and SP pack 46 corresponding to the respective languages exist in the VOBU 42. The language corresponding to the pack can be determined with reference to the pack header.

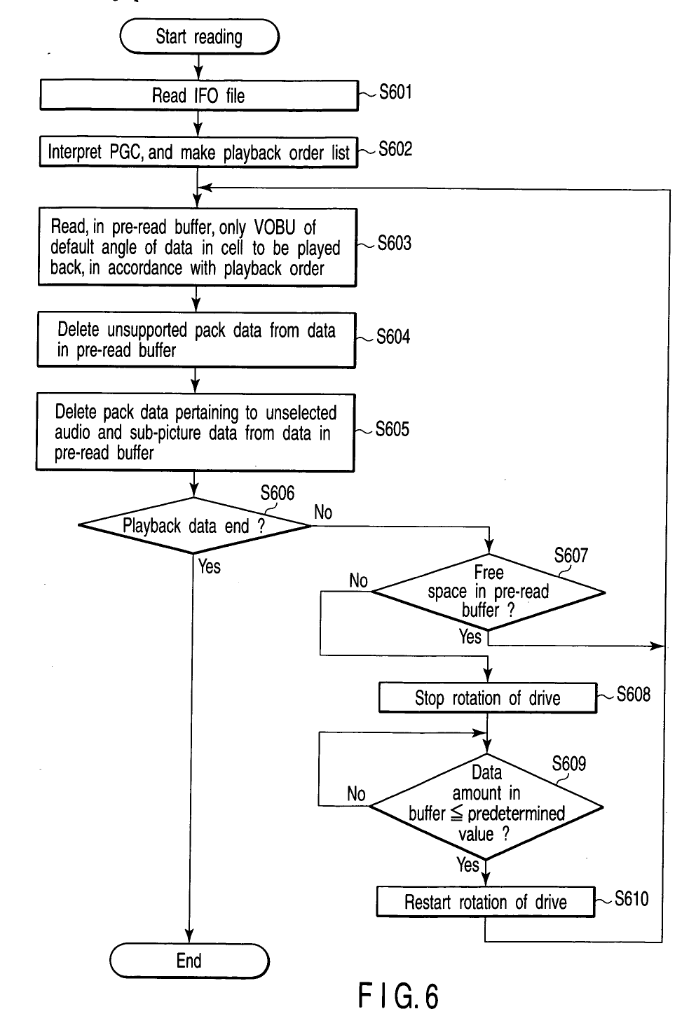

The process flow of the disc reading unit 102 when playing back the optical disc 20 will be described next. FIG. 6 is a flowchart showing the process flow of the disc reading unit 102 when playing back the optical disc 20.

First, the disc reading unit 102 controls the disc drive unit 101 to read the IFO file from the optical disc 20 (S601). Assume that the VTS_01_0_0.IFO 224 is read. Upon reading the VTS_10_0.IFO 224, the disc reading unit 102 transfers the VTS_01_0.IFO 224 to the navigation manager 103. The navigation manager 103 interprets the PGC to be played back, with reference to the VTS_01_0.IFO 224. Accordingly, a list of the playback order is made (S602).

Furthermore, under the control of the navigation manager 103, the disc reading unit 102 reads the data in the playback order of the cells 41 interpreted in step S602, and stores the read data in the pre-read buffer 104 (S603). In this embodiment, this process is performed for each VOBU 42.

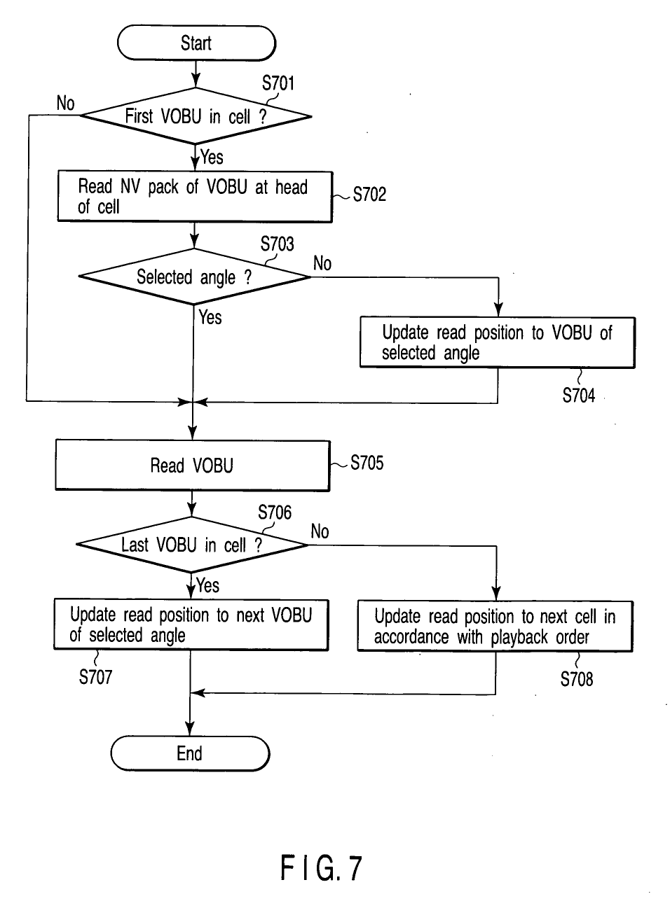

FIG. 7 is a flowchart for explaining a detailed process in step S603. The disc reading unit 102 determines whether the VOBU 42 to be read is at the head of the cell 41 (S701). If the VOBU 42 is at the head of the cell 41 (YES in S701), the disc reading unit 102 reads the NV pack 43 at the head of the VOBU 42 (S702). Upon reading the NV pack 43, the disc reading unit 102 can determine whether the VOBU 42 is of the selected angle based on a comparison result between the angle number in the NV pack 43 and the angle number of the angle information 103c contained in the navigation manager 103 (S703). If the VOBU 42 in this process is not of the selected angle (NO in S703), the disc reading unit 102 updates a read position to the VOBU 42 of the selected angle (S704). The relative address to the VOBU 42 of the selected angle is indicated in the NV pack 43 of the VOBU 42 processed before updating the read position. Hence, the read position is updated on the basis of the relative address.

When the read position matches the VOBU 42 pertaining to the default angle (NO in S701, YES in S703, and S704), the disc reading unit 102 reads the VOBU 42 at the read position (S705). The disc reading unit 102 also determines whether the read VOBU 42 is the last VOBU 42 to be played back in the cell 41 to which the VOBU 42 belongs (S706). If the VOBU 42 is not the last (NO in S706), the read position is updated to the VOBU 42 to be played back next of the selected angle (S707). The relative address to the VOBU 42 to be played back next can be determined on the basis of the NV pack 43.

If the VOBU 42 is the last VOBU 42 to be played back in the cell 41 to which the VOBU 42 belongs (YES in S706), the disc reading unit 102 updates the read position to the cell 41 to be played back next on the basis of the playback order analyzed in step S602 shown in FIG. 6 (S708).

Referring back to FIG. 6, the disc reading unit 102 deletes, from the pre-read buffer 104, the pack data which does not support playback of the data read in the pre-read buffer 104 (S604). The data which does not support playback is the data in a compression scheme which is not supported by the video decoder 107, audio decoder 109, or the like. The data can be determined by reading the header of the pack data. Note that the disc reading unit 102 separately stores, in the HDD 105, the data deleted from the pre-read buffer 104.

Subsequently, the disc reading unit 102 deletes, from the data stored in the pre-read buffer 104, the A pack 45 and SP pack 46 which respectively pertain to the unselected audio and subtitle data of the data stored in the pre-read buffer 104 (S605). As described above, with reference to the header of each pack, it can be determined whether the A pack 45 or SP pack 46 pertains to the selected language. More specifically, it can be determined whether the A pack 45 or SP pack 46 pertains to the selected language by comparing the audio stream number or sub-picture number in the header of the A pack 45 or SP pack 46, with the audio stream number serving as the audio information 103a or the sub-picture number serving as the sub-picture information 103b of the navigation manager 103. Note that the disc reading unit 102 separately stores, in the HDD 105, the data deleted from the pre-read buffer 104.

The disc reading unit 102 also determines whether all the playback data pertaining to the currently played back PGC has been read (S606). If all the data has been read (YES in S606), the reading process ends.

If all the data has not been read (NO in S606), the disc reading unit 102 determines whether the pre-read buffer 104 has a free capacity (S607). If the pre-read buffer 104 has a free capacity (YES in S607), the data is further read at the read position updated in S707 or S708 shown in FIG. 7 (S603).

If the pre-read buffer 104 has no free capacity (NO in S607), the disc reading unit 102 stops rotating the disc drive unit 101 (S608). After stopping rotation of the disc drive unit 101, the disc reading unit 102 determines whether the data amount in the pre-read buffer 104 has become equal to or smaller than a predetermined amount (S609). If this data amount is larger than the predetermined amount (NO in S609), the disc drive unit 101 is kept stopped (S609).

If the data amount in the pre-read buffer 104 is equal to or smaller than the predetermined amount (YES in S609), the disc reading unit 102 restarts rotating the disc drive unit 101 (S610), and the data is read from the optical disc 20 in the playback order of the PCGs generated in S602 (S603).

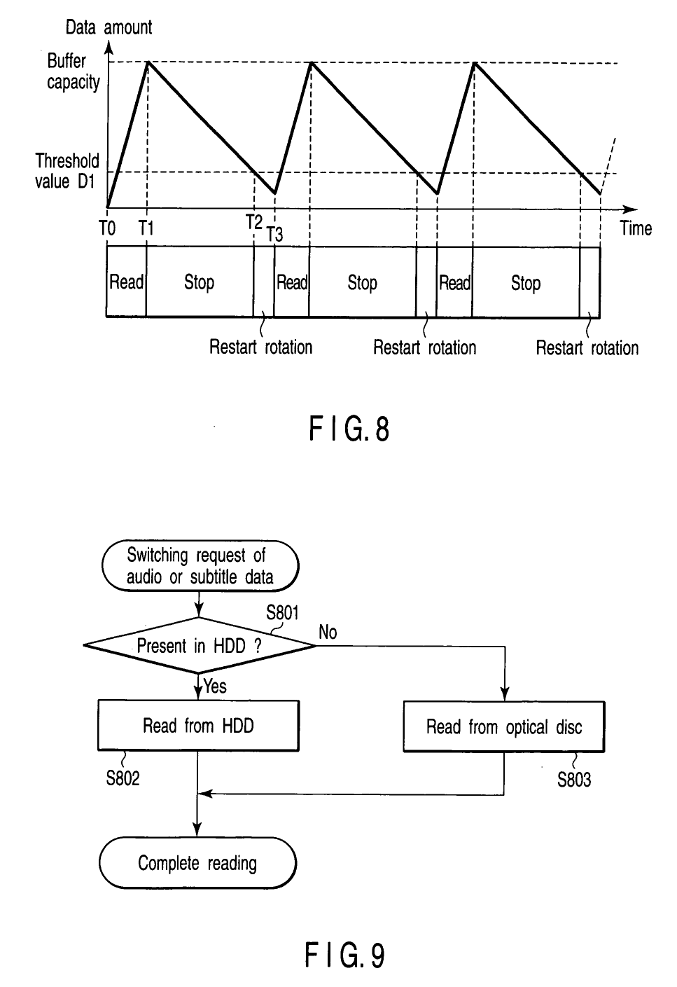

FIG. 8 is a timing chart showing the relationship between the control of the disc drive unit 101 performed by the disc reading unit 102, and the data amount in the pre-read buffer 104.

When the disc drive unit 101 starts reading the data from the optical disc 20 (time T0 in FIG. 8), the disc reading unit 102 stores the data in the pre-read buffer 104, thereby increasing the data amount in the pre-read buffer 104 (corresponding to S603, S604, S605, NO in S606, and YES in S607 in FIG. 6). In FIG. 8, the data amount is shown to increase linearly. However, actually, the data amount does not linearly increase because data is deleted from the pre-read buffer 104 in S604 and S605.

When the pre-read buffer 104 has no free capacity (corresponding to time T1 in FIG. 8, and NO in S607 in FIG. 6), the disc reading unit 102 causes the disc drive unit 101 to stop rotation of the optical disc 20 (corresponding to S608 in FIG. 6). During this time, the disc reading unit 102 reads the data from the pre-read buffer 104, and transfers the data to the demultiplexer 106 for playback, and the data amount in the pre-read buffer 104 decreases. In FIG. 8, the data amount in the buffer is illustrated to decrease linearly. However, actually, the data amount does not always decrease linearly.

When the data amount in the pre-read buffer 104 becomes equal to or smaller than a predetermined threshold value D1 (time T2 in FIG. 8), the disc reading unit 102 causes the disc drive unit 101 to restart rotational control (S611 in FIG. 6). Upon restarting reading the data (time T3 in FIG. 8), the data is read again from the optical disc 20 until the data amount reaches the buffer capacity. After that, as described above, the disc reading unit 102 causes the disc drive unit 101 to read the data from the optical disc 20, stops rotating the disc drive unit 101, and restarts rotational control of the disc drive unit 101, repeatedly.

FIG. 9 shows a process flow of the disc reading unit 102 when the user issues a switching request of audio or subtitle data. Upon receipt of the switching request of audio or subtitle data from the user, the disc reading unit 102 determines whether the data pertaining to the audio or subtitle data is stored in the HDD 105 (S801). If the data is stored in the HDD (YES in S801), it is read from the HDD 105 (S802). If the audio or subtitle data is not stored in the HDD (NO in step S801), it is read from the disc drive unit 101 (S803). At this time, if the rotation of the disc drive unit 101 is stopped, the disc reading unit 102 causes the disc drive unit 101 to restart rotational control in order to read the data from the optical disc 20.

As described above, according to this embodiment, the pre-read buffer 104 has a relatively large capacity, and the rotational control performed by the disc drive unit 101 is temporarily stopped. Hence, power consumption for reading the data can be decreased. The PGCI 312 is read from the optical disc 20, and the data is read in the playback order of the PGCs in the PGCI 312. Hence, as compared with a case wherein a predetermined amount of data is obtained from, e.g., the designated read address, the amount of unnecessary data which is not used in playback processing can be reduced, thus increasing memory use efficiency.

For example, as shown in FIG. 4, there are the VTS_01_1.VOB 227 including cells C_IDN#1 to C_IDN#3, the VTS_01_2.VOB 228 including cells C_IDN#1 and C_IDN#2, and the VTS_01_i.VOB 229 including cells C_IDN#1 to C_IDN#j. Assume that the PGC information PGCI#1 is defined to play back these cells in the order of the cells C_IDNI#1 and C_IDN#2 of the VTS_01_1.VOB 227, the cell C_IDN#2 of the VTS_01_2.VOB 228, and the cell C_IDN#j of the VTS_01_i.VOB 229. When the PGC is played back based on the PGCI#1, the disc reading unit 102 reads the cells in the order of the cells C_IDNI#1 and C_IDN#2 of the VTS_01_1.VOB 227, the cell C_IDN#2 of the VTS_01_2.VOB 228, and the cell C_IDN#j of the VTS_01_i.VOB 229 for each cell 41. In other words, the data in the cell 41 which is not included in the PGC to be played back is not read.

Furthermore, the NV pack 43 is interpreted, and the VOBU 42 of the unselected angle is not read, thus increasing the memory use efficiency. Hence, the disc reading unit 102 decreases the access frequency to the disc drive unit 101, thus suppressing power consumption.

In this embodiment, the A pack 45 and SP pack 46 respectively pertaining to the unselected audio and subtitle data, and the data which is not supported by the video decoder 107, or audio decoder 109 are deleted from the pre-read buffer 104. After that, new data is read in the free area, thus increasing the memory use efficiency of the pre-read buffer 104.

Additionally, in this embodiment, the data deleted from the pre-read buffer 104 is stored in the HDD 105, and the stored data can be read from the HDD 105 when the user switches the audio and subtitle data. Hence, the access frequency to the disc drive unit 101 can also be decreased.

In this embodiment, the data is not read at once until the pre-read buffer 104 becomes full of data in step S603, but is read for each VOBU 42. While reading the data, a playback process is performed. When the data is read in a large unit, a large amount of data is read, which must then be deleted in steps S604 and S605 is read. However, in this embodiment, the data is read for each VOBU 42, thus suppressing this problem.

In this embodiment, when the pre-read buffer 104 becomes full of data, the rotation of the disc drive unit 101 is stopped to save power. However, as another method of saving power, for example, a method of stopping power supply to an optical pickup of the disc drive unit 101, stopping control of the optical pickup, stopping output of the laser beam, or their combination is also available.

In this embodiment, the process when the VTS_01_0.IFO 224 is read is described. However, the same process can be performed when the PGC is played back on the basis of the VIDEO_TS.IFO 221 serving as the management file pertaining to a menu.

In this embodiment, the case when the notebook PC 10 is used is described as an example. However, the optical disc playback apparatus may be a normal DVD player and the like.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An optical disc playback apparatus which plays back an optical disc on which a plurality of data units to be played back are recorded, comprising:
a reading unit configured to read data from the optical disc by controlling an optical disc drive; and
a temporary storage unit configured to temporarily store the data read by the reading unit,
wherein the reading unit performs power saving control for the optical disc drive when an amount of the data stored in the temporary storage unit reaches a first predetermined amount, and reads the data for each of the data units on the basis of playback order information which is read from the optical disc and pertains to a playback order of the data units.

2. An apparatus according to claim 1, wherein the first predetermined amount is a storage capacity of the temporary storage unit.

3. An apparatus according to claim 1, wherein the reading unit stops the power saving control when a remaining amount of the data stored in the temporary storage unit becomes not more than a second predetermined amount.

4. An apparatus according to claim 1, wherein the reading unit causes the optical disc drive to stop rotation of the optical disc, as the power saving control.

5. An apparatus according to claim 1, wherein the data unit is constructed by not less than one data pack array including an audio data pack pertaining to audio data or a sub-picture data pack pertaining to sub-picture data, and
the reading unit deletes, from the temporary storage unit, unselected data serving as the audio data pack pertaining to audio data which is not selected in playback processing or the sub-picture data pack pertaining to sub-picture data which is not selected in playback processing, of data stored in the temporary storage unit.

6. An apparatus according to claim 5, which further comprises a magnetic disc apparatus configured to store the unselected data deleted from the temporary storage unit by the reading unit, and in which the reading unit reads the unselected data from the magnetic disc apparatus when switching the audio data or the sub-picture data in playback processing.

7. An apparatus according to claim 1, wherein the reading unit deletes, from the temporary storage unit, the data which is not supported by a decoder which decodes data in playback processing, of the data stored in the temporary storage unit.

8. An optical disc playback apparatus which plays back an optical disc, comprising:
a reading unit configured to read data from the optical disc by controlling an optical disc drive; and
a temporary storage unit configured to temporarily store the data read by the reading unit,
wherein the reading unit performs power saving control for the optical disc drive when an amount of the data stored in the temporary storage unit reaches a predetermined amount, and deletes, from the temporary storage unit, an unselected data pertaining to audio data or sub-picture data which is not selected in playback processing, of the data stored in the temporary storage unit.

9. An apparatus according to claim 8, wherein
a plurality of data units to be played back are recorded in a time-serial manner on the optical disc,
each of the data units is constructed by not less than one data pack array including an audio data pack pertaining to the audio data or a sub-picture data pack pertaining to the sub-picture data, and
the unselected data is the audio data pack pertaining to the audio data which is not selected in playback processing, or the sub-picture data pack pertaining to the sub-picture data which is not selected in playback processing.

10. A control program for controlling an optical disc playback apparatus which plays back an optical disc on which a plurality of data units to be played back are recorded, comprising:
a reading function of reading data from the optical disc by controlling an optical disc drive; and
a temporary storage function of temporarily storing, in a buffer, the data read on the basis of the reading function,
wherein on the basis of the reading function, power saving control is performed for the optical disc drive when an amount of the data stored in the buffer reaches a first predetermined amount, and
the data is read for each of the data units on the basis of playback order information which is read from the optical disc and pertains to a playback order of the data units.

11. A program according to claim 10, wherein the predetermined amount is a storage capacity of the buffer.

12. A program according to claim 10, wherein on the basis of the reading function, the power saving control is stopped when a remaining amount of the data stored in the buffer becomes not more than a second predetermined amount.

13. A program according to claim 10, wherein
each of the data units is constructed by not less than one data pack array including an audio data pack pertaining to the audio data or a sub-picture data pack pertaining to the sub-picture data, and
on the basis of the temporary storage function, the unselected data is deleted from the buffer, the unselected data serving as the audio data pack pertaining to the audio data which is not selected in playback processing, or the sub-picture data pack pertaining to the sub-picture data which is not selected in playback processing, of the data stored in the buffer.

14. A program according to claim 13, wherein on the basis of the temporary storage function, the unselected data deleted from the buffer is stored in a magnetic disc apparatus.

15. A program according to claim 10, wherein on the basis of the temporary storage function, the data which is not supported by a decoder which decodes data in playback processing of the data stored in the buffer is deleted from the buffer.
